(19) United States
(12) Patent Application Publication
(10) Pub. No.: US 2007/0013763 A1
(43) Pub. Date: Jan. 18, 2007

(54) Laser scanning unit and image forming apparatus having the same

(75) Inventors: Hyung-soo Kim, Suwon-si (KR); Kyung-nam Jang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/385,764

(22) Filed: Mar. 22, 2006

(30) Foreign Application Priority Data
Jul. 14, 2005 (KR) 2005-0063780

(51) Int. Cl. B41J 2/385

(52) U.S. Cl. 347/134

(57) ABSTRACT

A laser scanning unit includes a first optical system having a plurality of beam sources. A first optical deflector respectively deflects beams emitted from the beam sources in different directions. A plurality of scanning lenses correct errors of the beams deflected from the first optical deflector. A plurality of reflection mirrors respectively reflect the beams passing through the scanning lenses to a plurality of surfaces to be scanned. A second optical system has a plurality of beam sources. A second optical deflector respectively deflects beams emitted from the beam sources of the second optical system in different directions. A plurality of scanning lenses correct errors of the beams deflected from the second optical deflector. A plurality of reflection mirrors respectively reflect the beams passing through the scanning lenses to a plurality of surfaces to be scanned. At least the first and the second optical deflectors of the first and the second optical systems are respectively arranged on planes different from each other.

### CROSS-REFERENCE TO RELATED APPLICATIONS

This application claims the benefit under 35 U.S.C. § 119(a) of Korean Patent Application No. 2005-63780, filed on Jul. 14, 2005 in the Korean Intellectual Property Office, the entire contents of which are hereby incorporated by reference.

### BACKGROUND OF THE INVENTION

1. Field of the Invention

The present invention relates to a laser scanning unit used in an image forming apparatus, such as a printer or a copying machine. More particularly, the present invention relates to a laser scanning unit (hereinafter, referred to as “LSU”) having plural beam sources for simultaneously scanning laser beams on surfaces of plural photosensitive bodies, such as photosensitive drums, to form images thereon, and an image forming apparatus having the same.

2. Description of the Related Art

Generally, a tandem color image forming apparatus includes an image forming unit having a plurality of developing devices, an LSU having a plurality of optical systems arranged in parallel, and a plurality of photosensitive bodies on the surfaces of which developer images of different colors to each other are formed by the image forming unit.

Compared to a general color image forming apparatus for forming color images by rotating one photosensitive body several times, the tandem color image forming apparatus forms color images by rotating plural photosensitive bodies only once. Thus, there is an advantage in that desired color images can be obtained at high speed. Accordingly, the tandem color image forming apparatus has mostly been used so far.

FIG. 1 shows a conventional tandem color image apparatus 1. The tandem type color image forming apparatus 1 includes an LSU 8 and four drum-shaped photosensitive bodies 1C, 1M, 1Y and 1BK.

The LSU 8 is provided with first and second scanning optical systems 9 and 30 arranged parallel in two rows to scan laser beams on the surfaces of the respective photosensitive bodies 1C, 1M, 1Y and 1BK. The first and the second scanning optical systems 9 and 30 are integrally contained in an optical case 17.

As shown in FIGS. 2A and 2B, the first and the second scanning optical systems 9 and 30 are connected to connecting parts 19 at both ends of the optical case 17 in a main scanning direction. A through-space 11 is arranged at the center portion between the connecting parts 19. The through-space 11 is formed such that the optical performance of the first and the second scanning optical systems 9 and 30 is sustained as an initial state by preventing structural deformation of components of the first and the second scanning optical systems 9 and 30 generated due to a temperature rise at scanning time. The four edge portions of the optical case 17 are fixed with four fixing devices 18, respectively.

In each of the first and the second 9 and 30, laser beams emitted from semiconductor lasers 11a and 11b after being optically modulated based on image information are respectively scanned in different directions by a polygonal mirror 12. The polygonal mirror 12 has four reflection surfaces and is rotated by a motor 16. The polygonal mirror 12 and the motor 16 form an optical deflector.

Each of the laser beams B1 and B2 scanned by the polygonal mirror 12 transmits through a sheet of first scanning lenses 13a or 13b, and is changed in a direction by a reflection mirror 14a or 14b. Next, each of the laser beams B1 and B2 is transmitted through two sheets of second scanning or F-theta lenses 15a or 15b, and then forms an image on the surface of each photosensitive body 1C, 1M, 1Y or 1BK.

The conventional tandem color image forming apparatus 1, configured in this manner, has a structure in that the LSU 8 uses two polygonal mirrors 12 and scans two laser beams on each of the polygonal mirrors 12, thereby reducing the number of the polygonal mirrors 12.

However, the tandem color image forming apparatus 1 has a disadvantage in that the first and the second scanning optical systems 9 and 30 are connected to connecting parts 19 at both ends of the optical case 17 in a main scanning direction, and a through-space 11 is arranged at the center portion between the connecting parts 19. Therefore, the width of the LSU 8 becomes broader, and the distance between photosensitive bodies 1C, 1M, 1Y and 1BK and the first and the second scanning optical systems 9 and 30 becomes more distant. Accordingly, the size of the LSU 8 becomes larger, so that a compact tandem color image forming apparatus 1 cannot be embodied.

Also, since the tandem color image forming apparatus 1 has a structure in that the reflection mirrors 14a and 14b for changing optical paths between the first and the second scanning lenses 13a and 13b and 15a and 15b are used, a performance of forming an image depends on surface accuracy. Therefore, there is a disadvantage in that manufacturing costs are increased when reflection mirrors 14a and 14b having an excellent surface accuracy are used to increase surface accuracy.

Also, in the tandem color image forming apparatus 1, because the first and the second scanning optical systems 9 and 30 uses the polygon mirrors 12 each having four reflection surfaces, there is a limit to the enhancement of a scan speed even though a rotation speed of the polygon mirrors is increased to enhance a scan speed.

Accordingly, a need exists for an image forming apparatus having an improved laser scanning unit that minimizes the degradation of image quality while reducing the size of the laser scanning unit.

### SUMMARY OF THE INVENTION

Accordingly, an aspect of the present invention is to provide a laser scanning unit capable of reducing the width and size of an LSU by respectively arranging first and second optical deflectors of first and second scanning optical systems on different planes from each other, and an image forming apparatus having the same.

Another aspect of the present invention is to provide a laser scanning unit capable of minimizing the degradation of image quality due to the surface accuracy of a reflection mirror by respectively depositing reflection mirrors of first and second scanning optical systems between a scanning lens and a photosensitive body, and an image forming apparatus having the same.

Still another aspect of the present invention is to provide a laser scanning unit capable of simplifying its configuration and improving productivity by rendering angles of laser beams incident to first and second optical deflectors from beam sources of first and second scanning optical systems and installation angles of the beam sources satisfied with a predetermined condition, and an image forming apparatus having the same.

A laser scanning unit includes a first optical system having a plurality of beam sources, and a first optical deflector for respectively deflecting beams emitted from the beam sources in different directions. A plurality of scanning lenses correct errors of the beams deflected from the first optical deflector and a plurality of reflection mirrors for respectively reflecting the beams passing through the scanning lenses to a plurality of surfaces to be scanned. A second optical system has a plurality of beam sources, and a second optical deflector for respectively deflecting beams emitted from the beam sources in different directions. A plurality of scanning lenses correct errors of the beams deflected from the second optical deflector. A plurality of reflection mirrors respectively reflect the beams passing through the scanning lenses to a plurality of surfaces to be scanned. At least the first and the second optical deflectors of the first and the second optical systems are respectively arranged on planes different from each other.

According to an exemplary implementation of the present invention, an interval (2×P) between the centers of three adjacent surfaces to be scanned among the plurality of surfaces to be scanned, having beams emitted from the first and the second optical systems, is set to become larger than at least one of a distance (L) from one of the first and the second optical systems to the surface to be scanned and an interval (C) between the centers of the first and the second optical deflectors. At least one of the first and the second optical systems may include at least one optical path changing mirror for changing an optical path such that intervals (P) between the centers of the surfaces to be scanned are substantially identical to each other.

According to an exemplary implementation of the present invention, the first optical deflector substantially simultaneously deflects each beam emitted from the plurality of correspondent beam sources in different directions and sets such that an angle (A) between the incident angles of beams emitted from the plurality of correspondent beam sources to the first optical deflector becomes approximately twice that of one divided reflection surface of the first optical deflector. Preferably, the second optical deflector substantially simultaneously deflects each beam emitted from the plurality of correspondent beam sources in different directions and sets such that an angle (A) between the incident angles of beams emitted from the plurality of correspondent beam sources to the second optical deflector becomes approximately twice that of one divided reflection surface of the second optical deflector. At least one incident correction mirror may be arranged between each of the plurality of beam sources of the first and the second optical systems, and the first and the second optical deflectors.

According to an exemplary implementation of the present invention, the plurality of beam sources of the first and the second optical systems are arranged such that arrangement angles of scanning directions for the mutual beam sources are substantially parallel to each other.

According to an exemplary implementation of the present invention, each of the plural beam sources of the first and the second optical systems has at least one beam emitting point.

Each of the plural scanning lenses of the first and the second optical systems has a sheet of a plastic asymmetric spherical lens.

In accordance with another exemplary embodiment of the present invention, an image forming apparatus includes a plurality of photosensitive bodies on each of which electrostatic latent images are formed. A laser scanning unit has a first optical system including a plurality of beam sources, and a first optical deflector for respectively deflecting beams emitted from the beam sources in different directions. A plurality of scanning lenses correct errors of the beams deflected from the first optical deflector. A plurality of reflection mirrors respectively reflect the beams passing through the scanning lenses to a first group of photosensitive bodies among the plurality of photosensitive bodies. A second optical system includes a plurality of beam sources, and a second optical deflector for respectively deflecting beams emitted from the beam sources in different directions. A plurality of scanning lenses correct errors of the beams deflected from the second optical deflector. A plurality of reflection mirrors respectively reflect the beams passing through the scanning lenses to a second group of photosensitive bodies among the plurality of photosensitive bodies. At least the first and the second optical deflectors of the first and the second optical systems are respectively arranged on planes different from each other.

According to an exemplary implementation of the present invention, an interval (2×P) between the centers of three adjacent photosensitive bodies among the plurality of photosensitive bodies is set to become larger than at least one of a distance (L) from one of the first and the second optical systems to the photosensitive body and an interval (C) between the centers of the first and the second optical deflectors. At least one of the first and the second optical systems may have at least one optical path changing mirror for changing an optical path such that intervals (P) between the centers of the surfaces to be scanned are substantially identical to each other.

According to an exemplary implementation of the present invention, the first optical deflector substantially simultaneously deflects each beam emitted from the plurality of correspondent beam sources in different directions and sets such that an angle (A) between the incident angles of beams emitted from the plurality of correspondent beam sources to the first optical deflector becomes approximately twice that of one divided reflection surface of the first optical deflector. Preferably, the second optical deflector substantially simultaneously deflects each beam emitted from the plurality of correspondent beam sources in different directions and sets such that an angle (A) between the incident angles of beams emitted from the plurality of correspondent beam sources to the second optical deflector becomes approximately twice that of one divided reflection surface of the second optical deflector. At least one incident correction mirror may be arranged between each of the plurality of beam sources of the first and the second optical systems, and the first and the second optical deflectors.

According to an exemplary implementation of the present invention, the plurality of beam sources of the first and the second optical systems are arranged such that arrangement angles of scanning directions for the mutual beam sources are substantially parallel to each other.

According to an exemplary implementation of the present invention, each of the plural beam sources of the first and the second optical systems has at least one beam emitting point.

Each of the plural scanning lenses of the first and the second optical systems may have a sheet of a plastic asymmetric spherical lens.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWING FIGURES

The above aspect and other features of the present invention will become more apparent by describing in detail exemplary embodiments thereof with reference to the attached drawing figures, wherein:

FIG. 1 is a schematic view illustrating a conventional tandem color image forming apparatus;

FIGS. 2A and 2B are plan and sectional views illustrating a laser scanning unit of the conventional image forming apparatus of FIG. 1;

FIG. 3 is a schematic view of a tandem color image forming apparatus according to an exemplary embodiment of the present invention; and

FIGS. 4A and 4B are side elevational and top plan views of a laser scanning unit of the image forming apparatus of FIG. 3.

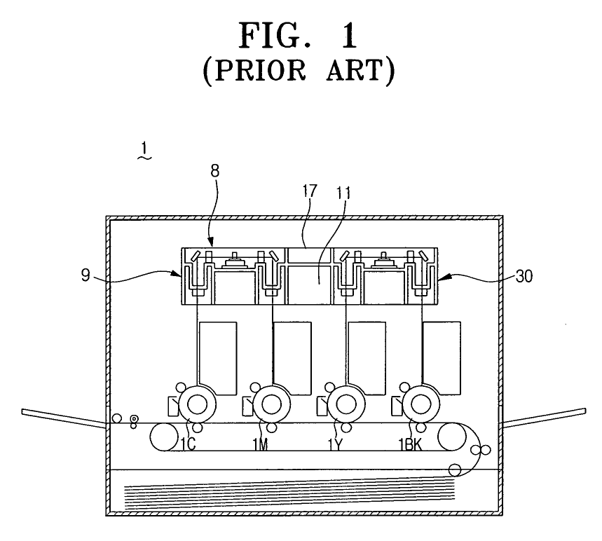

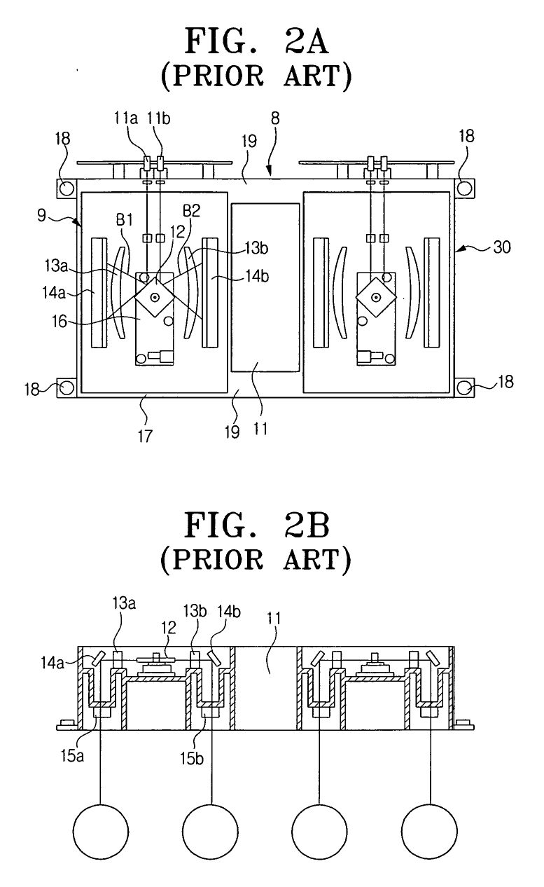

Throughout the drawings, the same drawing reference numerals will be understood to refer to the same elements, features, and structures.

### DETAILED DESCRIPTION OF EXEMPLARY EMBODIMENTS

Hereinafter, exemplary embodiments of the present invention are described in detail with reference to the accompanying drawing figures.

The matters defined in the description, such as a detailed construction and elements thereof, are provided to assist in a comprehensive understanding of the invention. Thus, it is apparent that the present invention may be carried out without those defined matters. Also, well-known functions or constructions are omitted to provide a clear and concise description.

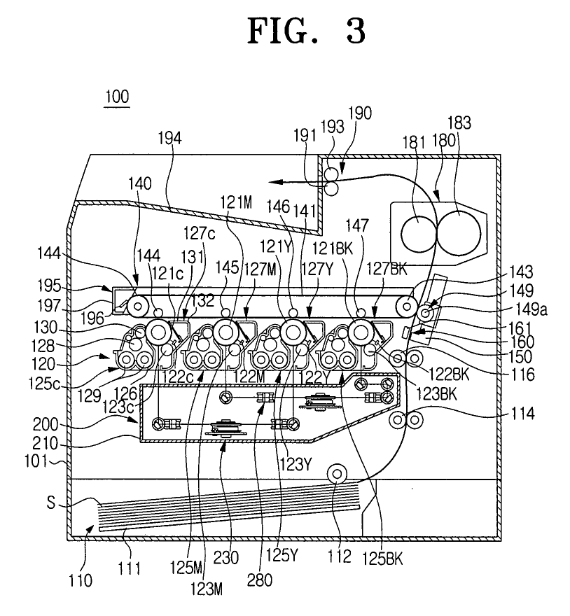

FIG. 3 is a schematic view of an image forming apparatus having a laser scanning unit according to an exemplary embodiment of the present invention.

The image forming apparatus according to an exemplary embodiment of the present invention is a tandem color electrophotographic printer 100 that prints by internally processing image information transmitted from a computer (not shown), a scanner (not shown) or the like.

As shown in FIG. 3, the tandem electrophotographic printer 100 of an exemplary embodiment of the present invention includes a paper feeding unit 110, an image forming unit 120, a transfer unit 140, a paper guide unit 160, a fixing unit 180, a paper discharging unit 190 and a cleaning unit 195.

The paper feeding unit 110 feeds an image receiving medium (S), such as a sheet of paper, and has a paper feeding cassette 111, a pickup roller 112, a register roller 114 and a conveying roller 116. The paper feeding cassette 111 is attached to the lower part of an apparatus body 101. The image receiving media (S) stacked in the paper feeding cassette 111 are picked up sheet by sheet by the pickup roller 112 and then transferred to the register roller 114 and the conveying roller 116.

The image forming unit 120 is arranged on the upper part of the paper feeding unit 110 and forms developer images representing predetermined colors, that is, cyan (C), magenta (M), yellow (Y) and black (BK), respectively.

The image forming unit 120 is provided with first, second, third and fourth photosensitive bodies 121C, 121M, 121Y and 121BK. The first, the second, the third and the fourth photosensitive bodies 121C, 121M, 121Y and 121BK are arranged in parallel facing the following image transfer belt 141 of the transfer unit 140. The first, the second, the third and the fourth photosensitive bodies 121C, 121M, 121Y and 121BK are OPC (organic photoconductive) drums each having an organic photoconductive layer coated on the circumferential surface of am aluminum cylinder and being supported such that both ends of the cylinder may be rotated by flanges. The first, the second, the third and the fourth photosensitive bodies 121C, 121M, 121Y and 121BK are contacted with the image transfer belt 141 by first transfer rollers 144, 145, 146 and 147 to form a nip under a constant pressure and are rotated clockwise by a gear train (not shown) receiving power transmitted from a driving motor (not shown).

In the vicinity of the first, the second, the third and the fourth photosensitive bodies 121C, 121M, 121Y and 121BK, are respectively arranged first, second, third and fourth charging units 123C, 123M, 123Y and 123BK; first, second, third and fourth developing devices 125C, 125M, 125Y and 125BK; first, second, third and fourth erasing units 122C, 122M, 122Y and 122BK; and first, second, third and fourth cleaning units 127C, 127M, 127Y and 127BK, respectively.

Each of the first, the second, the third and the fourth charging units 123C, 123M, 123Y and 123BK is provided with a conductive roller. The surfaces of the first, the second, the third and the fourth charging units 123C, 123M, 123Y and 123BK respectively contact the surfaces of the corresponding first, second, third and fourth photosensitive bodies 121C, 121M, 121Y and 121BK. A fixed charging bias voltage is applied to the conductive roller from a charging bias power source unit (not shown) by the control of a control unit (not shown) to form a fixed charging potential on the surfaces of the corresponding first, second, third and fourth photosensitive bodies 121C, 121M, 121Y and 121BK.

The first, the second, the third and the fourth developing devices 125C, 125M, 125Y and 125BK respectively attach corresponding color developers on the surfaces of the corresponding first, second, third and fourth photosensitive bodies 121C, 121M, 121Y and 121BK having latent electrostatic images formed thereon to develop them as visible developer images. Each of the first, the second, the third and the fourth developing devices 125C, 125M, 125Y and 125BK is provided with a developer receiving part 126, a developing roller 130 and a developer supply roller 128.

The developer storage part 126 stores developers of cyan (C), magenta (M), yellow (Y) and black (BK) with a certain polarity, such as toners.

The developing roller 130 attaches a developer on a latent electrostatic image formed on the surface of the first, second, third or fourth photosensitive body 121C, 121M, 121Y or 121BK by the LSU 200, to develop it, and is rotated while engaging the corresponding first, second, third or fourth photosensitive body 121C, 121M, 121Y or 121BK. The developing roller 130 contacts the surface of the first, second, third or fourth photosensitive body 121C, 121M, 121Y or 121BK and are separated from each other by a fixed interval, and is rotated clockwise by a power transmitting gear (not shown) connected with a gear train driving the photosensitive bodies 121C, 121M, 121Y and 121BK. A fixed developing bias voltage lower than that of the developer supply roller 128 is applied to the developing roller 130 from a developing bias power source unit (not shown) by the control of the control unit.

The developer supply roller 128 supplies a developer to the developing roller 130 using a potential difference between the developer supply roller 128 and the developing roller 130. The surface of the developer supply roller contacts the bottom surface of one side of the developing roller 130 to form a nip therebetween. The developers of cyan (C), magenta (M), yellow (Y) and black (BK) are conveyed into the space formed between bottom surfaces of the developer supply roller 128 and the developing roller 130 within the developer by stirring rollers 129.

Furthermore, a fixed developer supply bias voltage higher than that of the developer supply roller 130 is applied to the developer supply roller 128 from the developing bias power source unit (not shown) by the control of the control unit. Thus, the developer within the space formed between bottom surfaces of the developer supply roller 128 and the developing roller 130 is charged while receiving electric charges injected by the developer supply roller 128, and attached onto the surface of the developing roller 130 having a relatively low potential, then moved into the nip formed between the developer supply roller 128 and the developing roller 130.

Each of the erasing units 122C, 122M, 122Y and 122BK has an erasing lamp to erase charging potential charged on the surface of the first, the second, the third or the fourth photosensitive bodies 121C, 121M, 121Y or 121BK.

Each of the first, the second, the third and the fourth cleaning units 127C, 127M, 127Y and 127BK has a cleaning blade 131 for photosensitive body and a photosensitive body waste developer receiving unit 132 to eliminate a residual developer remaining on the surface of the correspondent first, second, third or fourth photosensitive bodies 121C, 121M, 121Y or 121BK after the first, the second, the third and the fourth photosensitive bodies 121C, 121M, 121Y and 121BK are rotated for one period.

The cleaning blade 131 for photosensitive body is fixed to contact the surface of the corresponding photosensitive body 121C, 121M, 121Y or 121BK under a substantially constant pressure.

The waste developer receiving unit 132 for photosensitive body stores a waste developer removed by being cleaned from the correspondent photosensitive body 121C, 121M, 121Y or 121BK by the cleaning blade 131 for a photosensitive body. The waste developer receiving unit 132 for the photosensitive body has the corresponding first, second, third or fourth charging unit 123C, 123M, 123Y or 123BK and the corresponding first, second, third or fourth erasing units 122C, 122M, 122Y or 122BK partitioned by barrier walls (not shown) therein.

The first, the second, the third and the fourth photosensitive units 121C, 121M, 121Y and 121BK; the first, the second, the third and the fourth charging units 123C, 123M, 123Y and 123BK; the first, the second, the third and the fourth developing devices 125C, 125M, 125Y and 125BK; the first, the second, the third and the fourth erasing units 122C, 122M, 122Y and 122BK; and the first, the second, the third and the fourth cleaning units 127C, 127M, 127Y and 127BK are respectively modularized in a body as four process cartridges to be attached and detached to the apparatus body 101.

An LSU 200 is disposed below the modularized four process cartridges.

The LSU 200 irradiates laser beams on the surfaces of the first, the second, the third and the fourth photosensitive bodies 121C, 121M, 121Y and 121BK, charged at a fixed potential by the first, the second, the third and the fourth charging units 123C, 123M, 123Y and 123BK, in accordance with image signals input from a computer, a scanner or the like, and then forms latent electrostatic images having a low potential part at the fixed potential lower than a charge potential.

The LSU 200 includes first and second scanning optical systems 230 and 280 fixed to an optical case 210.

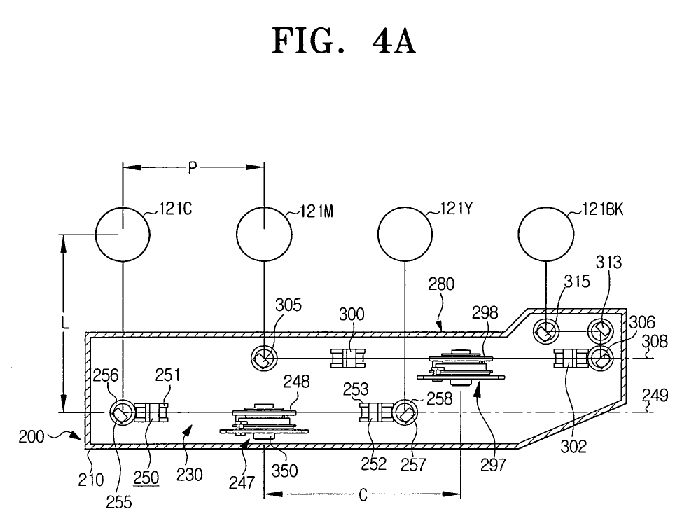

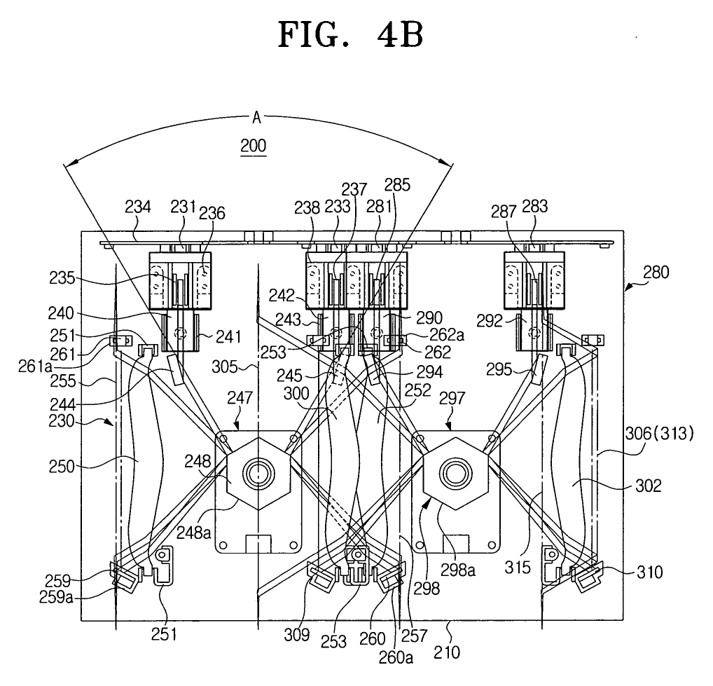

As shown in FIGS. 4A and 4B, the first scanning optical system 230 forms latent electrostatic images on the surfaces of the first and the third photosensitive bodies 121C and 121Y in accordance with image signals. The first scanning optical system 230 includes first and second semiconductor laser 231 and 233, first and second collimator lenses 235 and 237, first and second cylinder lenses 240 and 242, a first optical deflector 247, first and second scanning or F-theta lenses 250 and 252, and first and second reflection mirrors 255 and 257 (dotted lines in FIG. 4B).

The first scanning optical system 230 is arranged such that an interval (2×P) between the centers of three adjacent photosensitive bodies among the first, the second, the third and the fourth photosensitive bodies 121C, 121M, 121Y and 121BK becomes larger than a distance (L) from a first plane 249 having a component of the first scanning optical system, inter alia, the first optical deflector 247 disposed thereon to the photosensitive bodies 121C, 121M, 121Y and 121B, as follows:
2×P>L (1)

The first and the second semiconductor lasers 231 and 233 are used as beam sources and emit laser beams containing image signals. The first and the second semiconductor lasers 231 and 233 are disposed on a printed circuit board 234 installed substantially perpendicularly to the optical case 210 being separated from each other by a fixed interval. Each of the first and the second semiconductor lasers 231 and 233 has a laser diode (LD). Alternately, each of the first and the second semiconductor lasers 231 and 233 has a plurality of LDs.

The first and the second collimator lenses 235 and 237 render the laser beams emitted from the first and second LDs 231 and 233 into substantially parallel beams with respect to an optical axis. The first and the second collimator lenses 235 and 237 are fixed to the optical case 210 with fixing brackets 236 and 238, respectively.

The first and the second cylinder lenses 240 and 242 make the substantially parallel beams emitted from the first and the second collimator lenses 235 and 237 into linear beams substantially parallel to a sub scanning direction. The first and the second cylinder lenses 240 and 242 are fixed to the optical case 210 with fixing brackets 241 and 243, respectively.

Each of the horizontal linear beams passing through the first and the second cylinder lenses 240 and 242 is incident into the first optical deflector 247 to form an angle (A) by first and second incident angle correction mirrors 244 and 245 as described in detail below.

The first optical deflector 247 has a first polygonal mirror 248 and a first scanning motor 350.

The first polygonal mirror 248 simultaneously deflects the horizontal linear beams passing through the first and the second cylinder lenses 240 and 242 at a constant linear velocity. To enhance a printing speed, the first polygonal mirror 248 has, for example, six reflection surfaces and an outer diameter below approximately 40 mm. The first scanning motor 350 is disposed beneath the bottom of the first polygonal mirror 248 to rotate the first polygonal mirror 248 at a substantially constant linear velocity, as shown in FIG. 4A.

As shown in FIG. 4B, to deflect the horizontal linear beams passing through the first and the second cylinder lenses 240 and 242 to be substantially symmetric to each other with respect to the plane of a main scanning direction, an angle (A) between incident angles at which the horizontal linear beams are incident on the first polygonal mirror 248 by the first and the second incident angle correction mirrors 244 and 245 is set to be approximately twice than that of one reflection surface 248a of the first polygonal mirror 248 as follows:
A=(360/N)×2 (2)
wherein N is the number of the reflection surfaces 248a of the first polygon mirror 248.

That is, if the number of the reflection surfaces 248a is 6 as shown in the first polygonal mirror 248 of an exemplary embodiment shown in FIG. 4B, the angle (A) between incident angles at which the horizontal linear beams are incident on the first polygonal mirror 248 by the first and the second incident angle correction mirrors 244 and 245 is 120 degrees.

The first and the second scanning lenses 250 and 252 are fixed to the optical case 210 with fixing brackets 251 and 253, respectively.

Each of the first and the second scanning lenses 250 and 252 is formed into a sheet of a plastic asymmetric spherical lens having a constant refractive index with respect to an optical axis to reduce the number of components and minimize the size of the LSU 200.

The first and the second scanning lenses 250 and 252 respectively adjust the focus on surfaces of the first and the third photosensitive bodies 121C and 121Y, being a surface to be scanned, after refracting laser beams reflected from the polygonal mirror 248 in a main scanning direction and correcting the aberration of the laser beams reflected from the polygonal mirror 248.

The first and the second reflection mirrors 255 and 257 reflect the laser beams passing through the first and the second scanning lenses 250 and 252 from the F-theta lens 125 in a certain direction to scan the laser beams on the surfaces of the first and the third photosensitive bodies 121C and 121Y. The first and the second reflection mirrors 255 and 257 are supported to the optical case 210 with fixing brackets 256 and 258 (FIG. 4A), respectively.

The first and the second horizontal synchronization mirrors 259 and 260 reflect the laser beams passing through the first and the second scanning lenses 250 and 252 in a horizontal direction to first and second synchronization signal detection sensor 261 and 262. The first and the second horizontal synchronization mirrors 259 and 260 are supported to the optical case 210 with fixing brackets 259a and 260a, respectively.

The first and the second synchronization signal detection sensors 261 and 262 are fixed to the optical case 210 with fixing brackets 261a and 262a, respectively. The first and the second synchronization signal detection sensors 261 and 262 receive the laser beams reflected from the first and the second synchronization mirrors 259 and 260, and then output detection signals to an LSU control circuit (not shown) mounted on the printed circuit board 234 or on a separate printed circuit board (not shown). The detection signals output from the first and the second synchronization signal detection sensors 261 and 262 are used to adjust the scanning synchronization of the first and the second semiconductor lasers 231 and 233 through the LSU control circuit.

Depending on a surface angle of the first polygonal mirror 248, the laser beams reflected at a certain angle from the first polygonal mirror 248 are incident on the surfaces of the first and the third photosensitive bodies 121C and 121Y in the main scanning direction, thereby forming latent electrostatic images for certain colors, that is, cyan (C) and yellow (Y) on the surfaces of the first and the third photosensitive bodies 121C and 121Y. Multiple scan lines corresponding to the video signals are also formed along the sub scanning direction, crossing at right angles with the main scanning direction while the first and the third photosensitive bodies 121C and 121Y are being rotated.

At this time, the first and the second synchronization signal detection sensors 261 and 262 receive the laser beams reflected from the first and the second horizontal synchronization mirrors 259 and 260, and output detection signals to the LSU control circuit, respectively. Furthermore, the LSU control circuit adjusts the horizontal synchronization of the first and the second semiconductor lasers 231 and 233 depending on the detection signals, so that a starting point of each of the scan lines is substantially constantly sustained.

The second scanning optical system 280 forms latent electrostatic images on the surfaces of the second and the fourth photosensitive bodies 121M and 121BK in accordance with image signals. The second scanning optical system 280 includes third and fourth semiconductor laser 281 and 283, third and fourth collimator lenses 285 and 287, third and fourth cylinder lenses 290 and 292, a second optical deflector 297, third and fourth scanning lenses 300 and 302, third and fourth reflection mirrors 305 and 306, third and fourth incident angle correction mirrors 294 and 295, and third and fourth horizontal synchronization mirrors 309 and 310.

The configuration of the components of the second scanning optical system 280 is substantially identical to that of the first scanning optical system 230.

However, as shown in FIG. 4A, the second scanning optical system 280 is disposed in a second plane where the second optical deflector 297, third and fourth scanning lenses 300 and 302, and third and fourth reflection mirrors 305 and 306 are separated from each other by a fixed interval in the main scanning direction from the first plane to reduce the entire width of the LSU 200.

Furthermore, the second scanning optical system 280 is arranged such that an interval (2×P) between the centers of three adjacent photosensitive bodies among the first, the second, the third and the fourth photosensitive bodies 121C, 121M, 121Y and 121BK becomes larger than an interval (C) between the centers of the first and the second optical deflectors 247 and 297 as follows:
2×P>C (3)

Furthermore, the second scanning optical system 280 further includes first and second optical path changing mirrors 313 and 315 for changing optical paths. The first and the second optical path changing mirrors 313 and 315 render an interval (P) between the centers of the adjacent third and fourth photosensitive bodies 121Y and 121BK substantially identical to that between the centers of the other first, second and third photosensitive bodies 121C, 121M and 121Y.

As described above, the LSU 200 of an exemplary embodiment of the present invention makes the first and the second optical deflectors 247 and 297 of the first and the second scanning optical systems 230 and 280 respectively disposed on the planes 249 and 308 different from each other, thereby reducing not only the entire width of the LSU 200 but also the interval between the LSU and the photosensitive bodies 121C, 121M, 121Y and 121BK. Accordingly, the size of the LSU 200 and that of the printer 100 in accordance therewith may be reduced.

Also, in the LSU 100 of an exemplary embodiment of the present invetion, each of the first, the second, the third and the fourth reflection mirrors 255, 257, 305 and 306 of the first and the second scanning optical systems 230 and 280 is disposed between a sheet of the first, the second, the third or the fourth scanning lenses 250, 252, 300 or 302, and the first, the second, the third or the fourth photosensitive bodies 121C, 121M, 121Y or 121BK, thereby minimizing the degradation of image quality due to surface accuracy of the reflection mirrors 255, 257, 305 and 306.

Also, the LSU 100 of an exemplary embodiment of the present invention is configured such that an angle (A) between the incident angles of laser beams respectively incident from the first and the second semiconductor lasers 231 and 233 of the first scanning optical system 230, and the third and the fourth semiconductor lasers 281 and 283 of the second scanning optical system 280 into the first and the second optical deflectors 247 and 297 is set to become approximately twice as large as that between one reflection surface 248a and 298a of the first and the second polygonal mirrors 248 and 298 of the first and the second optical deflectors 247 and 297, and that the scan direction arrangement angles of the first, the second, the third and the fourth semiconductor lasers 231, 233, 281 and 283 are substantially parallel to each other by respectively arranging the first, the second, the third and the fourth incident angle correction mirrors 244, 245, 294 and 295 between the first, the second, the third and the fourth cylinder lenses 240, 242, 290 and 292, and the first and the second optical deflectors 247 and 297, thereby simplifying its configuration and thus improving productivity.

Referring back to FIG. 3, the transfer unit 140 transfers developer images formed on the surfaces of the first, the second, the third and the fourth photosensitive bodies 121C, 121M, 121Y and 121BK onto an image receiving medium (S). The transfer unit 140 is provided with an image transfer belt 141, four first transfer rollers 144, 145, 146 and 147, and a second transfer roller 149.

The image transfer belt 141 conveys developer images formed on the surfaces of the first, the second, the third and the fourth photosensitive bodies 121C, 121M, 121Y and 121BK to an image receiving medium (S). The image transfer belt 141 is installed such that the transfer roller 141 may be rotated in a medium conveying direction (counterclockwise in FIG. 3) by a driving roller 143 and a driven roller 144.

An organic photoconductive layer is coated on the surface of the image transfer belt 141 such that developer images formed on the surfaces of the first, the second, the third and the fourth photosensitive bodies 121C, 121M, 121Y and 121BK may be transferred thereon.

The first transfer roller 144, 145, 146 and 147 is respectively arranged to pressurize the image transfer belt 141 with a substantially constant pressure inside the image transfer belt 141 with respect to the corresponding first, second, third or fourth photosensitive body 121C, 121M, 121Y or 121BK, so that developer images formed on the surfaces of the first, the second, the third and the fourth photosensitive bodies 121C, 121M, 121Y and 121BK may be transferred onto the image transfer belt 141. Furthermore, a fixed first transfer bias voltage is applied to the first transfer rollers 144, 145, 146 and 147 by a transfer bias power source unit (not shown) controlled by the control of the control unit.

The second transfer roller 149 transfers the developer image transferred on the image transfer belt 141 onto an image receiving medium (S). The second transfer roller 149 is arranged to press the image receiving medium (S) with a fixed pressure with respect to the driving roller 143. Furthermore, a fixed second transfer bias voltage is applied to the second transfer roller 149 by the transfer bias power source unit controlled by the control of the control unit.

The paper guide unit 160 has a conveying guide unit 161 for guiding an image receiving medium (S) into the nip between the image transfer belt 141 and the second transfer roller 149 when the image receiving medium (S) is entered into the transfer unit 140 by the conveying roller 116 of the paper feeding unit 110. The conveying guide unit 161 is fixed to a fixing bracket (not shown) installed on a moving frame 150 for supporting a shaft 149a of the second transfer roller 149.

The fusing unit 180 has a heating roller 181 and a pressure roller 183 to fuse the developer image transferred on the image receiving medium (S). A heater (not shown) is installed within the heating roller 181 to fuse the developer image on the image receiving medium (S) with a high-temperature heat. The pressure roller 183 is installed to pressurize the image receiving medium (S) by an elastic pressure mechanism (not shown).

The paper discharging unit 190 has a paper discharging roller 191 and a backup roller 193 to discharge the image receiving medium (S) having the developer image fused thereon into a paper discharge tray 194.

The cleaning unit 195 is disposed at one side of the image transfer belt 141 and provided with a belt cleaning blade 196 and a belt waste developer receiving part 197.

The belt cleaning blade 196 is installed to pressurize the image transfer belt 141 with a substantially constant pressure at one side of the driven roller 144. The belt cleaning blade 196 cleans and then removes waste developer remaining on the surface of the image transfer belt 141 after being rotated for one period (or revolution). The belt waste developer receiving part 197 receives and then stores the waste developer removed from the image transfer belt 141.

Although it is illustrated and described that the LSU 200 of an image forming apparatus according to an exemplary embodiment of the present invention is applied to a tandem electrophotographic printer 100 wherein developer images formed on the surfaces of the first, the second, the third and the fourth photosensitive bodies 121C, 121M, 121Y and 121BK are not immediately transferred onto an image receiving medium (S) but transferred on the image receiving medium (S) through the image transfer belt 141, the present invention is not limited to such an embodiment. That is, the LSU 200 of an image forming apparatus according to another exemplary embodiment of the present invention may be applied to another image forming apparatus, for example, a tandem color image forming apparatus (not shown), wherein developer images formed on the surfaces of the first, the second, the third and the fourth photosensitive bodies 121C, 121M, 121Y and 121BK is immediately transferred onto an image receiving medium (S).

Also, although it is illustrated and described that the LSU 200 of an image forming apparatus according to an exemplary embodiment of the present invention is applied to only a tandem electrophotographic printer 100 for executing printing on a single side of the paper, it is apparent that the LSU 200 may be applied to a tandem color image forming apparatus (not shown) for printing on both sides of the paper.

Operation of the tandem electrophotographic printer 100 according to an exemplary embodiment of the present invention is described in detail with reference to FIGS. 3, 4A and 4B, as follows.

First, when a printing instruction is input through a computer or a control panel, a control unit outputs control signals to an LSU control circuit in accordance with image signals input from an external device, such as a computer or a scanner, so that laser beams are emitted through first, second, third and fourth semiconductor lasers 231, 233, 281 and 283.

The laser beams emitted through the first, the second, the third and the fourth semiconductor laser 231, 233, 281 and 283 respectively pass through first, second, third and fourth collimator lenses 235, 237, 285 and 287; first, second, third and fourth cylinder lenses 240, 242, 290 and 292; first and second optical deflectors 247 and 297; first, second, third and fourth scanning lenses 250, 252, 300 an 302; and first, second, third and fourth reflection mirrors 255, 257, 305 and 306, and then are substantially simultaneously incident on the surfaces of first, second, third and fourth photosensitive bodies 121C, 121M, 121Y and 121BK in a main scanning direction. Thus, latent electrostatic images for forming developer images of cyan (C), magenta (M), yellow (Y) and black (BK) are formed on the surfaces of the first, the second, the third and the fourth photosensitive bodies 121C, 121M, 121Y and 121BK.

Subsequently, the latent electrostatic images formed on the surfaces of the first, the second, the third and the fourth photosensitive bodies 121C, 121M, 121Y and 121BK are respectively developed to visible images as the developer images of cyan (C), magenta (M), yellow (Y) and black (BK) through first, second, third and fourth developing devices 125C, 125M, 125Y and 125BK.

While the first, the second, the third and the fourth photosensitive bodies 121C, 121M, 121Y and 121BK, and the image transfer belt 141 are being rotated, the developer images formed on the surfaces of the first, the second, the third and the fourth photosensitive bodies 121C, 121M, 121Y and 121BK are conveyed into a nip between the first, the second, the third and the fourth photosensitive bodies 121C, 121M, 121Y and 121BK, and the image transfer belt 141, and then reiteratively transferred onto the image transfer belt 141 with fixed pressure and first transfer bias voltage applied to the image transfer belt 141 by first transfer rollers 144, 145, 146 and 147.

After the developer images are transferred, developers remaining on the surfaces of the first, the second, the third and the fourth photosensitive bodies 121C, 121M, 121Y and 121BK are removed by cleaning blades 131 of first, second, third and fourth cleaning units 127C, 127M, 127Y and 127BK. The removed developers are received in a waste developer receiving part 132 for each photosensitive body. Then, the first, the second, the third and the fourth photosensitive bodies 121C, 121M, 121Y and 121BK, having toners removed therefrom, are respectively charged with a fixed potential by first, second, third and fourth charging units 123C, 123M, 123Y and 123BK to form the next images.

Image receiving media (S) stacked in a paper feeding cassette 111 are sequentially picked up sheet by sheet by a pickup roller 112, and then conveyed into a nip between the image transfer belt 141 and the second transfer roller 149 by a register roller 114 and a conveying roller 116, being synchronized with image signal output timing.

While the image receiving medium S is passing through the nip between the image transfer belt 141 and the second transfer roller 149, the developer images reiteratively transferred on the image transfer belt 141 with a second transfer bias voltage applied to the second transfer roller 149 are transferred onto the image receiving medium S.

After the developer images are transferred, developers remaining on the surfaces of the image transfer belt 141 are removed by a belt cleaning blade 196 of a cleaning unit 195. The removed developer is received in a belt waste developer receiving part 197 while the image transfer belt 141 is being rotated.

Then, when the image receiving medium (S) reaches a fixing unit 180, the developer images transferred on the image receiving medium (S) are fixed as permanent images with a fixed heat and pressure applied by a heating roller 181 and a pressure roller 183 of the fixing unit 180.

After the developer images are fixed as permanent images, the image receiving medium (S) is discharged into a paper discharge tray 194 by a paper discharge roller 191 of the paper discharging unit 190.

As described above, in a laser scanning unit and an image forming apparatus having the same according to exemplary embodiments of the present invention, first and second optical deflectors of first and second scanning optical system are respectively arranged on planes different from each other, thereby reducing not only the entire width of an LSU but also the interval between photosensitive bodies and the LSU. Accordingly, the sizes of an LSU and an image forming apparatus in accordance therewith may be reduced.

Also, in a laser scanning unit and an image forming apparatus having the same according to an exemplary embodiment of the present invention, first, second, third and fourth reflection mirrors of first and second scanning optical systems are respectively disposed between a sheet of first, second, third and fourth scanning lenses, and first, second, third and fourth photosensitive bodies, thereby reducing degradation of image quality due to the surface accuracy of a reflection mirror.

Also, in a laser scanning unit and an image forming apparatus having the same according to an exemplary embodiment of the present invention, an LSU is configured such that the angle (A) between the incident angles of laser beams respectively incident from first and second semiconductor lasers of a first scanning optical system, and third and fourth semiconductor lasers of a second scanning optical system into first and second optical deflectors is set to be approximately twice as large as that between one reflection surfaces of first and second polygon mirrors of the first and the second optical deflectors. Scan direction arrangement angles of the first, the second, the third and the fourth semiconductor laser are substantially parallel to each other by respectively arranging first, second, third and fourth incident angle correction mirrors between first, second, third and fourth cylinder lenses, and the first and the second optical deflector, thereby simplifying its configuration and thus improving productivity.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A laser scanning unit, comprising:
a first optical system including
a first plurality of beam sources;
a first optical deflector for respectively deflecting beams emitted from the first plurality of beam sources in different directions;
a first plurality of scanning lenses for correcting errors of the beams deflected from the first optical deflector; and
a plurality of reflection mirrors for respectively reflecting the beams passing through the first plurality of scanning lenses to a first plurality of surfaces to be scanned; and
a second optical system including
a second plurality of beam sources;
a second optical deflector for respectively deflecting beams emitted from the second plurality of beam sources in different directions;
a second plurality of scanning lenses for correcting errors of the beams deflected from the second optical deflector; and
a second plurality of reflection mirrors for respectively reflecting the beams passing through the second plurality of scanning lenses to a second plurality of surfaces to be scanned;
wherein at least the first and the second optical deflectors of the first and second optical systems are respectively arranged on planes different from each other.

2. The laser scanning unit according to claim 1, wherein
an interval (2×P) between the centers of three adjacent surfaces to be scanned among the first and second plurality of surfaces to be scanned is larger than at least one of a distance (L) from one of the first and second optical systems to the surface to be scanned and an interval (C) between the centers of the first and second optical deflectors, where P is the distance between the centers of two adjacent surfaces to be scanned.

3. The laser scanning unit according to claim 2, wherein
at least one of the first and second optical systems has at least one optical path changing mirror for changing an optical path such that the intervals (P) between the centers of the surfaces to be scanned are substantially identical to each other.

4. The laser scanning unit according to claim 1, wherein
the first optical deflector substantially simultaneously deflects each beam emitted from the plurality of corresponding beam sources in different directions such that an angle (A) between the incident angles of beams emitted from the plurality of corresponding beam sources to the first optical deflector is approximately twice that of one divided reflection surface of the first optical deflector.

5. The laser scanning unit according to claim 4, wherein
the second optical deflector substantially simultaneously deflects each beam emitted from the plurality of corresponding beam sources in different directions such that an angle (A) between the incident angles of beams emitted from the plurality of corresponding beam sources to the second optical deflector is approximately twice that of one divided reflection surface of the second optical deflector.

6. The laser scanning unit according to claim 5, wherein
at least one incident correction mirror is arranged between each of the plurality of beam sources of the first and the second optical systems and the first and the second optical deflectors.

7. The laser scanning unit according to claim 1, wherein
the first and second plurality of beam sources of the first and the second optical systems are disposed such that arrangement angles of scanning directions for the first and second plurality of beam sources are substantially parallel to each other.

8. The laser scanning unit according to claim 1, wherein
each of the first and second plurality of beam sources of the first and the second optical systems has at least one beam emitting point.

9. The laser scanning unit according to claim 1, wherein
each of the first and second plurality of scanning lenses of the first and the second optical systems includes a sheet of a plastic asymmetric spherical lens.

10. An image forming apparatus, comprising:
a plurality of photosensitive bodies on each of which electrostatic latent images are formed; and
a laser scanning unit including
a first optical system including
a first plurality of beam sources;
a first optical deflector for respectively deflecting beams emitted from the first plurality of beam sources in different directions;
a first plurality of scanning lenses for correcting errors of the beams deflected from the first optical deflector; and
a first plurality of reflection mirrors for respectively reflecting the beams passing through the first plurality of scanning lenses to a first group of photosensitive bodies among the plurality of photosensitive bodies; and
a second optical system including
a second plurality of beam sources;
a second optical deflector for respectively deflecting beams emitted from the second plurality of beam sources in different directions;
a second plurality of scanning lenses for correcting errors of the beams deflected from the second optical deflector; and
a second plurality of reflection mirrors for respectively reflecting the beams passing through the second plurality of scanning lenses to a second group of photosensitive bodies among the plurality of photosensitive bodies;
wherein at least the first and second optical deflectors of the first and second optical systems are respectively arranged on planes different from each other.

11. The image forming apparatus according to claim 10, wherein
an interval (2×P) between the centers of three adjacent photosensitive bodies among the plurality of photosensitive bodies is larger than at least one of a distance (L) from one of the first and second optical systems to the photosensitive body to be scanned and an interval (C) between the centers of the first and second optical deflectors, where P is the distance between the centers of two adjacent photosensitive bodies.

12. The image forming apparatus according to claim 11, wherein
at least one of the first and second optical systems has at least one optical path changing mirror for changing an optical path such that the intervals (P) between the centers of the surfaces to be scanned are substantially identical to each other.

13. The image forming apparatus according to claim 10, wherein
the first optical deflector substantially simultaneously deflects each beam emitted from the first plurality of corresponding beam sources in different directions such that an angle (A) between the incident angles of beams emitted from the first plurality of corresponding bean sources to the first optical deflector is approximately twice that of one divided reflection surface of the first optical deflector.

14. The image forming apparatus according to claim 13, wherein
the second optical deflector substantially simultaneously deflects each beam emitted from the second plurality of corresponding beam sources in different directions such that an angle (A) between the incident angles of beams emitted from the second plurality of corresponding beam sources to the second optical deflector is approximately twice that of one divided reflection surface of the second optical deflector.

15. The image forming apparatus according to claim 14, wherein
at least one incident correction mirror is disposed between each of the first and second plurality of beam sources of the first and the second optical systems and the first and the second optical deflectors.

16. The image forming apparatus according to claim 10, wherein
the first and second plurality of beam sources of the first and second optical systems are arranged such that arrangement angles of scanning directions for the first and second plurality of beam sources are substantially parallel to each other.

17. The image forming apparatus as claimed in claim 10, wherein
each of the first and second plurality of beam sources of the first and second optical systems has at least one beam emitting point.

18. The image forming apparatus as claimed in claim 10, wherein
each of the first and second plurality of scanning lenses of the first and second optical systems has a sheet of a plastic asymmetric spherical lens.
